(19) United States
(12) Patent Application Publication
(10) Pub. No.: US 2013/0148641 A1
(43) Pub. Date: Jun. 13, 2013

(54) TECHNIQUES TO ACHIEVE ZERO ROAMING TIME FOR WORKGROUP BRIDGE DEVICES

(71) Applicants: Sidhananda Karthikeyan Sivaprakasam, Pondicherry (IN); Javier Contreras Albesa, Sant Cugat del Valles (ES); Kiran Kumar, Chennai (IN)

(72) Inventors: Sidhananda Karthikeyan Sivaprakasam, Pondicherry (IN); Javier Contreras Albesa, Sant Cugat del Valles (ES); Kiran Kumar, Chennai (IN)

(73) Assignee: CISCO TECHNOLOGY, INC., San Jose, CA (US)

(21) Appl. No.: 13/323,955

(22) Filed: Dec. 13, 2011

(51) Int. Cl. H04W 84/12

(52) U.S. Cl. 370/338

(57) ABSTRACT

Techniques are provided for providing seamless wireless communication services to client devices associated with an roaming workgroup bridge device to enable wireless communications between the client devices and a network using a first radio transceiver unit in communication with a first root access point device that provides connectivity to the network. The workgroup bridge device scans a frequency band to detect a second wireless root access point device using a second radio transceiver unit. Signal strength values of signals received by the first radio transceiver unit are compared to a threshold signal strength value. When the signal strength of the received signals is below the threshold, communication services are provided to the client devices using the second radio transceiver unit in communication with the second root access point device. Communications between the client devices and the first root access point device are then terminated.

### TECHNICAL FIELD

The present disclosure relates to wireless communications between workgroup bridge devices and access points.

### BACKGROUND

Workgroup bridge devices are generally deployed in moving vehicles or structures which may move at rapid speeds relative to root access points. As the vehicles or structures move through tunnels or pass other physical structures, radio frequency waves can undergo reflection properties resulting in a high likelihood that the workgroup bridge devices may select incorrect or inadequate root access points. Communication latency and increased roaming speeds may result when a workgroup bridge device chooses an incorrect root access point with which to initiate a network session. This, in turn, may result in frequent loss of data for client devices associated with the workgroup bridge device.

### BRIEF DESCRIPTION OF THE DRAWINGS

FIG. 1 shows an example network topology including a workgroup bridge device in communication with a plurality of wireless root access points to enable communications between client devices associated with the workgroup bridge and a network distribution layer associated with the wireless root access points.

FIG. 2 is an example of a block diagram of the workgroup bridge device configured to enable wireless communications between client devices and the network distribution layer using a plurality of radio transceiver units in communication with one or more of the access points.

FIG. 3 shows an example of a root access point database stored in the workgroup bridge device to maintain a list of detected root access points.

FIG. 4 is a flow chart depicting operations of the workgroup bridge device for providing wireless communication services to the client devices and scanning a frequency band of the network distribution layer for the root access points.

FIGS. 5A and 5B are flow charts depicting operations of the workgroup bridge device for transitioning wireless communication services from a serving radio transceiver unit to a scanning radio transceiver unit of the workgroup bridge device.

FIG. 6 is a flow chart depicting operations of the workgroup bridge device for operating a root access point scanning radio transceiver unit.

### DESCRIPTION OF EXAMPLE EMBODIMENTS

Overview

Techniques are provided for providing seamless wireless communication services to client devices associated with a high speed roaming workgroup bridge device. The wireless communication services enable wireless communications between the client devices and a network using a first radio transceiver unit of the workgroup bridge device in communication with a first wireless root access point device that is configured to provide connectivity to the network. In addition to providing the wireless communication services, the workgroup bridge device controls a second radio transceiver unit to scan a frequency band to detect a second wireless root access point device using a second radio transceiver unit of the workgroup bridge device. Signal strength values of signals received by the first radio transceiver unit from the first wireless root access point device are compared to a threshold signal strength value. Wireless communication services are provided to the client devices associated with the workgroup bridge device using the second radio transceiver unit of the workgroup bridge device in communication with the second wireless root access point device when the signal strength of the signals received by the first radio transceiver unit from the first wireless root access point is below the threshold signal strength value. The workgroup bridge device then terminates wireless communication services provided to the client devices by the first radio transceiver unit in communication with the first wireless root access point device only after establishing the connection with a second wireless root access point device.

### EXAMPLE EMBODIMENTS

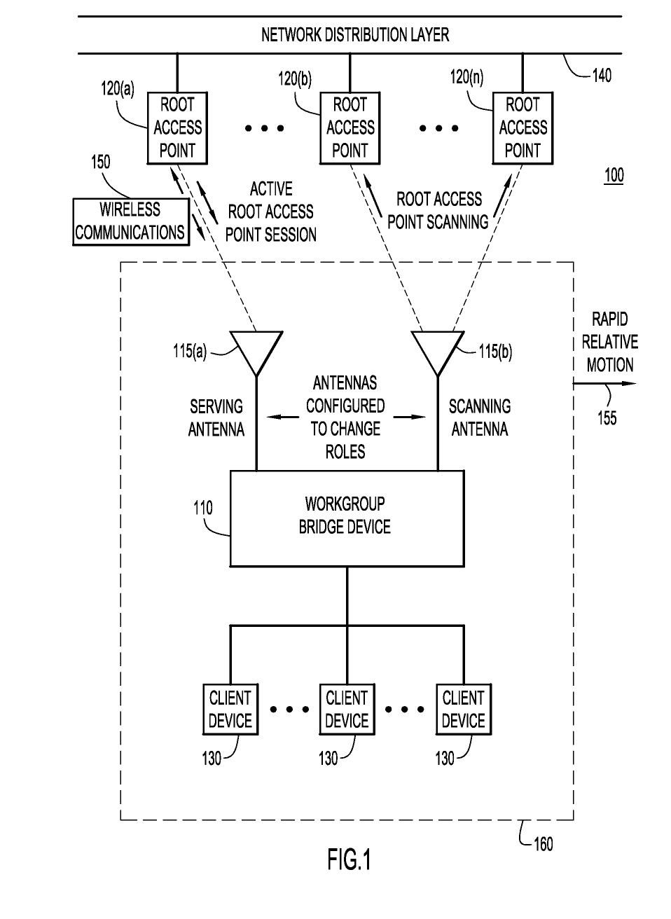

FIG. 1 shows an example network topology 100 with a workgroup bridge device in communication with a plurality of root access point devices and client devices. The workgroup bridge device, shown at reference numeral 110, has a plurality of antennas, shown at reference numerals 115(a) and 115(b). The workgroup bridge device 110 may be a wireless bridge in a network (e.g., a wireless local area network (WLAN) or a wireless wide area network (WWAN)) configured to receive and process wireless communications associated with a network distribution layer. The antennas 115(a) and 115(b) enable the workgroup bridge device 110 to communicate wirelessly with a plurality of root access point devices (herein “root access points”), shown at reference numerals 120(a) to 120(n), and with a plurality of client devices, shown at reference numeral 130. Though FIG. 1 shows two antennas 115(a) and 115(b) of the workgroup bridge device 110, it should be appreciated that the workgroup bridge device 110 may comprise any number of antennas to communicate with multiple root access points and client devices.

The root access points 120(a)-120(n) are connected (e.g., via a wired or wireless connection) to a network distribution layer 140. The root access points 120(a)-120(n) may be designed to operate, for example, in accordance with the Institute of Electrical and Electronic Engineers (IEEE) 802.11 communication standards. For example, an IEEE 802.11 capable access point may be shipped with a default configuration to operate as a root access point for wireless network communications with the network distribution layer 140.

Network frames and packets may be transmitted in the network topology 100 between the network distribution layer 140 and the client devices 130 via one or more of the root access points 120(a)-120(n) and the workgroup bridge device 110, as described herein. The root access points 120(a)-120(n) are configured to wirelessly communicate with the workgroup bridge device 110 via one or more of the plurality of antennas 115(a) and 115(b) of the workgroup bridge device 110. Similarly, the client devices 130 are configured to wirelessly communicate with the workgroup bridge device 110 via one or more of the plurality of antennas 115(a) and 115(b).

As shown in reference numeral 150, the workgroup bridge device 110 can enable or service wireless communications between the client devices 130 and one or more of the root access points 120(a)-120(n) to allow the client devices 130 to access the network distribution layer 140. For example, upstream packets and frames may be sent from the client devices 130 to the network distribution layer 140 via a link between the workgroup bridge device 110 and the client devices 130 and then via a wireless link between the workgroup bridge device 110 and one of the root access points 120(a)-120(n). FIG. 1 shows a wired link between the client devices and the workgroup bridge device 110, but it should be appreciated that any link (e.g., wired or wireless link) may be used. Likewise, downstream packets and frames may be sent from the network distribution layer 140 to the client devices 130 through the root access points 120(a)-120(n) (e.g., “parent” root access points) to the workgroup bridge device 110 and from the workgroup bridge device 110 to the destination client device. In general, the client devices 130 may be any network device connected to the workgroup bridge device 110 either through wireless or wired interfaces or links. For example, the client devices 130 may be mobile devices, laptop computers, tablet computers, smart phones, desktop personal computers, etc.

The antennas 115(a) and 115(b) of the workgroup bridge device 110 are coupled to radio transceiver units (not shown in FIG. 1) of the workgroup bridge device 110. For example, one of the antennas 115(a) and 115(b) may be coupled to a radio transceiver unit that is configured to perform “serving” functions that enable or service wireless network communications between the client devices 130 and any one of the parent root access points 120(a)-120(n). At the same time, another one of the antennas 115(a) and 115(b) may be coupled to a radio transceiver unit configured to perform “scanning” functions to detect another parent root access points 120(a)-120(n) while roaming, according to the techniques described herein. In FIG. 1, antenna 115(a) is depicted as a “serving” antenna coupled to a serving radio transceiver unit (not shown) and antenna 115(b) is depicted as a “scanning” antenna coupled to a scanning radio transceiver unit (not shown).

In FIG. 1, the serving antenna 115(a) enables wireless communications between the client devices 130 and the network distribution layer 140 via root access point 120(a). Thus, the serving antenna 115(a) is used to transmit upstream wireless communications received from the client devices 130 to the root access point 120(a) for transmission to the network distribution layer 140. Additionally, the serving antenna 115(a) is used to transmit downstream wireless communications originating from the network distribution layer 140 and received from the root access point 120(a) to the client devices 130. The scanning antenna 115(b) is configured to scan a frequency band to detect and prioritize other root access points (e.g., root access points 120(b)-120(n)) in the network topology 100. As described herein, the serving antenna 115(a) may be changed or switched to perform scanning operations, and the scanning antenna 115(b) may be changed or switched to perform serving operations.

FIG. 1 also shows, at reference numeral 155, that the workgroup bridge device 110 may be mounted on a vehicle or otherwise arranged to move rapidly with respect to the root access points 120(a)-120(n). For example, the workgroup bridge device 110 and the client devices 130 in wireless communication with the workgroup bridge device 110 may all reside within a single structure, depicted by reference numeral 160 (e.g., a high-speed train). The structure 160 may travel at rapid speeds relative to the root access points 120(a)-120(n), which may be stationary relative to the structure 160. In this example, at a first particular instance of time, the workgroup bridge device 110 may be near one root access point (e.g., root access point 120(a)) such that there is a relatively strong signal strength for wireless communications between the serving antenna 115(a) and that root access point.

At a second instance of time, the workgroup bridge device 110 may then move at a relatively rapid speed away from root access point 120(a) such that the signal strength between the serving antenna 115(a) and the root access point 120(a) weakens. In this example, the workgroup bridge device 110 may be closer to another root access point (e.g., root access point 120(b)) such that the signal strength between the root access point 120(b) and the serving antenna 115(a) is stronger than the signal strength between root access point 120(a) and the serving radio. As a result, the workgroup bridge device 110 may need to transition the wireless communications 150 between the client devices 130 and the network distribution layer 140 from root access point 120(a) to root access point 120(b) based on this signal strength, as described herein.

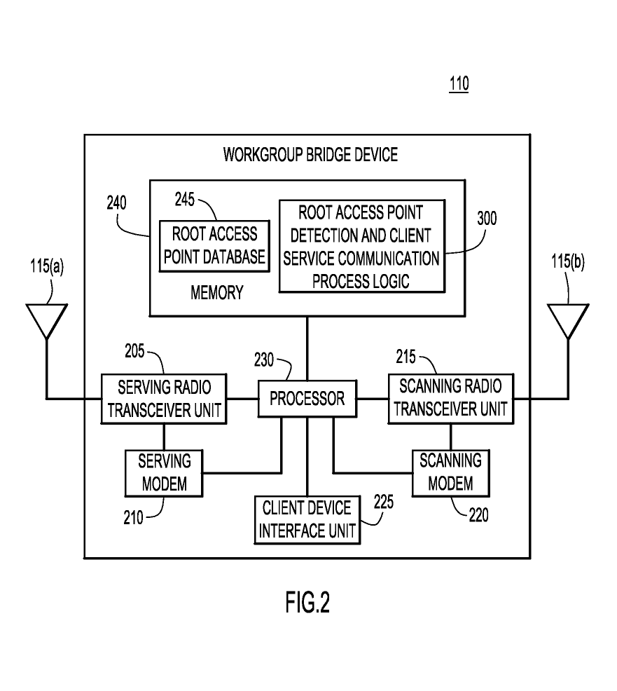

Turning to FIG. 2, an example block diagram of the workgroup bridge device 110 is now described. The workgroup bridge device 110 comprises antennas 115(a) and 115(b), a serving radio transceiver unit 205, a serving modem 210, a scanning radio transceiver unit 215, a scanning modem 220, a client device interface unit 225, a processor 230 and a memory 240. The serving radio transceiver unit 205 is coupled to the serving antenna 115(a) and to the serving modem 210. The serving radio transceiver unit 205 and the serving modem 210 are coupled to the processor 230. In response to instructions from the processor 230, the serving modem 210 generates signals for transmission by the serving radio transceiver unit 205 and processes signals received by the serving radio transceiver unit 205. The client device interface unit 225 is network interface device (e.g., Ethernet card) that enables networked communications with the client devices. Though the workgroup bridge device shows two radio transceiver units, it should be appreciated that the workgroup bridge device 110 may comprise any number of radio transceiver units that operate on any number of frequency bands.

The scanning radio transceiver unit 215 is coupled to the scanning antenna 115(b) and to the scanning modem 220. The scanning radio transceiver unit 215 and the scanning modem 220 are coupled to the processor 230. In response to instructions from the processor 230, the scanning radio transceiver unit 215 and the scanning modem 220 are controlled to scan a frequency band to detect signals from the root access points 120(a)-120(n) via the scanning antenna 115(b). It should be appreciated that the serving radio transceiver unit 205 and the scanning radio transceiver unit 215 are configured to communicate with both the client devices 130 and the root access points 120(a)-120(n). The serving radio transceiver unit 205 and the serving modem 210 may be embodied in one or more integrated circuits (“chip sets”), and the same applies to the scanning radio transceiver unit 215 and scanning modem 220.

The radio transceiver units 205 and 215 are configured to receive, via one or more of the antennas 115(a) and 115(b) downstream wireless communications from one or more root access points 120(a)-120(n). The radio transceiver units 205 and 215 are also configured to receive upstream communications from the client device interface unit 225 that is coupled to the processor 230. For example, the client devices 130 are configured to transmit upstream communications to the workgroup bridge 110 that are received via the client device interface unit 225 which then supplies these upstream communications to one of the radio transceiver units 205 or 215. Though not shown in FIG. 2, it should be appreciated that another radio transceiver unit may be used as the client device interface unit 225 to provide a wireless link between the workgroup bridge device 110 and the client devices 130. The radio transceiver units are configured to forward the upstream to an appropriate one or more of the root access points 120(a)-120(n), and the radio transceiver units are configured to forward downstream wireless communications (from one or more of the root access points 120(1)-120(n)) to an appropriate one or more of the client devices 130, via the client device interface unit 225. The radio transceiver units of the workgroup bridge device 110 are also configured to detect, via one or more of the antennas 115(a) and 115(b), root access points wirelessly by, for example, scanning a frequency band to detect root access points operating within the frequency band in the network topology 100, as described herein. The serving radio transceiver unit 205 and the scanning radio transceiver unit 215 may be configured to change or swap roles with each other, according to the techniques described herein.

For example, the role of the scanning radio transceiver unit 215 may be changed to enable the scanning radio transceiver unit 215 to transmit signals to and receive signals from the client device interface unit 225 (originating from the client devices 130) and root access points 120(a)-120(n) via the scanning antenna 115(b). Likewise, the role of the serving radio transceiver unit 205 may be changed to enable the serving radio transceiver unit 205 to scan the frequency band to detect the root access points 120(a)-120(n).

The serving and scanning operations may be performed simultaneously by respective radio transceiver units such that while the serving radio transceiver unit 205 performs the serving functions via the serving antenna 115(a), the scanning radio transceiver unit 215 performs the scanning functions via the scanning antenna 115(b), and vice versa.

The roles of the radio transceiver units and the antennas may change depending on the configuration of the workgroup bridge device 110, as described herein. For example, as the workgroup bridge device 110 moves relative to the root access points 120(a)-120(n), the workgroup bridge device 110 may also need to switch the roles of the serving radio transceiver unit 205 and the scanning radio transceiver unit 215 (and associated antennas 115(a) and 115(b)) rapidly. In other words, as the workgroup bridge device 110 moves at high speeds relative to the root access points 120(a)-120(n), the workgroup bridge device 110 may need to perform fast roaming between the root access points 120(a)-120(n) and may need to switch or change the serving and scanning operations performed by its radio transceiver units in order to ensure that wireless communications are maintained between the client devices 130 and the network distribution layer 140. These techniques are described in more detail herein.

In FIG. 2, the processor 230 is a microprocessor or microcontroller that is configured to execute program logic instructions (i.e., software) for carrying out various operations and tasks described herein. For example, the processor 230 is configured to execute root access point detection and client service communication process logic 300 that is stored in the memory 240 to provide wireless communication services to the client devices 130 and to scan a frequency band to detect root access points 120(a)-120(c) in the network topology 100. The memory 240 may comprise read only memory (ROM), random access memory (RAM), magnetic disk storage media devices, optical storage media devices, flash memory devices, electrical, optical or other physical/tangible memory storage devices.

The functions of the processor 230 may be implemented by logic encoded in one or more tangible computer readable storage media (e.g., embedded logic such as an application specific integrated circuit, digital signal processor instructions, software that is executed by a processor, etc.), wherein the memory 240 stores data used for the operations described herein and stores software or processor executable instructions that are executed to carry out the operations described herein.

The root access point detection and client service communications process logic 300 may take any of a variety of forms, so as to be encoded in one or more tangible computer readable memory media or storage device for execution, such as fixed logic or programmable logic (e.g., software/computer instructions executed by a processor), and the processor 230 may be an application specific integrated circuit (ASIC) that comprises fixed digital logic, or a combination thereof.

For example, the processor 230 may be embodied by digital logic gates in a fixed or programmable digital logic integrated circuit, which digital logic gates are configured to perform the root access point detection and client service communication process logic 300. In general, the root access point detection and client service communication process logic 300 may be embodied in one or more computer readable storage media encoded with software comprising computer executable instructions and when the software is executed operable to perform the operations described herein for the process logic 300.

The memory 240 also stores data for a root access point database 245. The root access point database 245 stores priority and status information associated with the root access points in the network topology 100. For example, as described herein, the root access point database 245 may indicate the relative priority level of every detected root access point in the network topology 100 (e.g., corresponding to the signal strength between the workgroup bridge device 110 and each of the root access points) and may also indicate whether or not there is an active session (e.g., an active network session) between each of the root access points and the workgroup bridge device 110.

As described above, the serving radio transceiver unit 205 and the scanning radio transceiver unit 215 may be configured to provide services to enable wireless communications between the client devices 130 and the network distribution layer 140, depending on the configuration of the workgroup bridge device 110. Also, the workgroup bridge device 110 may need to perform fast roaming between the root access points 120(a)-120(n) and may need to switch or change the serving and scanning operations performed by the radio transceiver units in order to ensure that continuous and uninterrupted wireless communication services are provided between the client devices 130 and the network distribution layer 140.

Normally, fast roaming can be performed by scanning a frequency band to select an appropriate root access point device and performing IEEE 802.11 message exchanges between the client devices and the newly selected root access point device. This technique, however, typically involves the use of a single antenna to perform the scanning and the message exchanges, which may cause significant delays and interruptions in wireless communications between the client devices 130 and the network distribution layer 140 as a new root access point is selected. Additionally, this technique causes further delays requiring that the newly selected access point obtain authentication keys (base/network session keys or BTKs) from a controller within a network, and subsequently requires the newly selected access point to derive a pairwise transient key (PTK) in order to communicate with a workgroup bridge device.

The techniques described herein alleviate these problems by using a dedicated radio transceiver unit (e.g., the serving radio transceiver unit 205) to service the wireless communications between the client devices 130 and the network distribution layer 140 and another dedicated radio transceiver unit (e.g., the scanning radio transceiver unit 215) to scan the network topology 100 for additional root access points. The techniques described herein also enable radio transceiver units to swap or change roles. Thus, according to the techniques herein, the workgroup bridge device 110 can provide continuous wireless communication services to the client devices 130 while simultaneously scanning the network topology 100 for more desirable root access points for access to the network distribution layer 140.

Additionally, since the serving radio transceiver unit 205 and the scanning radio transceiver unit 215 are able to change roles, the workgroup bridge device 110 can scan a frequency band to detect root access points in the network topology 100 and can store information associated with the detected root access points in the root access point database 245. The workgroup bridge device 110 can then designate higher priorities to the “best” or “better” root access points (e.g., the root access points which provide the strongest wireless connection). Based on this priority information, the workgroup bridge device 110 can connect to the “best” root access points to provide wireless communications between the client devices 130 and the network distribution layer 140.

For example, the serving radio transceiver unit 205 may originally provide wireless services to the client devices 130 via the root access point 120(a). The scanning radio transceiver unit 215 may detect a new root access point 120(b) in the network topology 100, and the workgroup bridge device 110 may determine that the root access point 120(b) is a “best” root access point for wireless communications with the network distribution layer 140 (e.g., because the signal between the workgroup bridge device 110 and the root access point 120(b) is stronger when compared to the root access point 120(a)). Accordingly, the workgroup bridge device 110 may transition the wireless communication services from the serving radio transceiver unit 205 to the scanning radio transceiver unit 215 such that the scanning radio transceiver unit 215 becomes responsible for the wireless communication services to the client devices via the root access point 120(b). The serving radio transceiver unit 120(a) may then terminate its wireless communication services to the client devices 130 and may perform scanning operations to scan and detect other root access points (e.g., a third root access point) in the network topology 100 in order to update the priority information for these other root access points. Thus, the workgroup bridge 110 is able to provide fast roaming (e.g., zero roaming time) between root access points to enable continuous wireless communications between the client devices 130 and the network distribution layer 140.

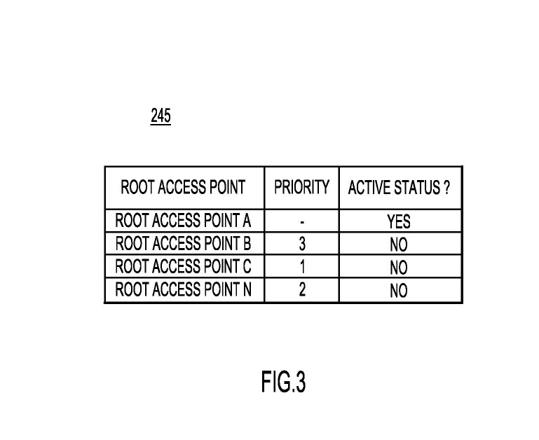

Turning to FIG. 3, an example of the root access point database 245 is shown. The root access point database 245 comprises a list of root access points (e.g., root access points 120(a)-120(n)) in the network topology 100 that have been detected by the workgroup bridge device 110. As described above, the scanning radio transceiver unit 215 (or the serving radio transceiver unit 205, depending on the configuration of the workgroup bridge device 110) is configured to scan a frequency band to detect one or more of the root access points 120(a)-120(n) in the network topology 100. When a root access point is detected, the workgroup bridge device 110 evaluates the signal strength between the root access point and the workgroup bridge device 110 and assigns a relative priority to each of the detected root access points based on the signal strength value between the root access point and the workgroup bridge device 110. Relatively high signal strength values result in relatively high priorities, while relatively low signal strength values result in relatively low priorities.

The root access point database 245 also stores active status information associated with each root access point. For example, in FIG. 3, the root access point database 245 indicates that root access point “A” (e.g., root access point 120(a)) has an active session with the workgroup bridge device 110 (e.g., that the workgroup bridge device 110 is wirelessly connected to root access point “A” to provide wireless communication services to the client devices 130), and the other root access points B-N are inactive. The inactive root access points are assigned a relative priority based on detected signal strength values between the root access points and the workgroup bridge device 110 priority. In this example, if the workgroup bridge device 110, initially communicating with a first root access point (root access point “A” above), later decides to select a new root access point with which to have an active session, the root access point “C” will be selected since it has the highest priority. The workgroup bridge device 110 will then indicate that root access point “C” has an active session with the workgroup bridge device 110 and will assign a relative priority to the now inactive root access point “A.”

When the workgroup bridge device 110 and the client devices 130 are deployed in structure 160 (FIG. 1) such as a high-speed train, the workgroup bridge device 110 may move rapidly relative to the root access points 120(a)-120(n). Thus, the signal strength between the workgroup bridge device 110 and each of the root access points 120(a)-120(n) may change rapidly based on, for example, the proximity of the workgroup bridge device 110 to respective ones of the root access points 120(a)-120(n). By having a dedicated serving radio transceiver unit 205 and a dedicated scanning radio transceiver unit 215, the workgroup bridge device 110 is able to determine which root access point is the “best” root access point to enable wireless communications with the client devices 130 (e.g., which root access point is the “best parent” root access point), while simultaneously providing the wireless communication services.

In one example, as described herein, the scanning radio transceiver unit 215 can also perform pre-authentication with potential “best parent” root access points in accordance with proprietary key management authentication techniques or other industry standards, such as those set forth in IEEE 802.11r. In this example, the scanning radio transceiver unit 215, in the course of scanning a frequency band and detecting existing root access points, can pre-negotiate (e.g., generate) authentication keys with each of the detected radio access points. Thus, when the workgroup bridge device 110 decides to switch to a new “best parent” root access point, it will already be authenticated with the new “best parent” root access point since the scanning radio transceiver unit 215 has already authenticated (e.g., using the authentication keys) with the new “best parent” root access point. As a result, the workgroup bridge device 110 can rapidly change roles to enable wireless communication services between the client devices and the new “best parent” root access point. The serving radio transceiver unit 205 also changes roles to perform the scanning and detecting of root access points previously performed by the scanning radio transceiver unit 215. This enables the workgroup bridge device 110 to roam between root access points by pre-authenticating with the root access points, thus allowing the workgroup bridge device 110 to minimize or eliminate any interruption to the wireless communication services provided to the client devices 130.

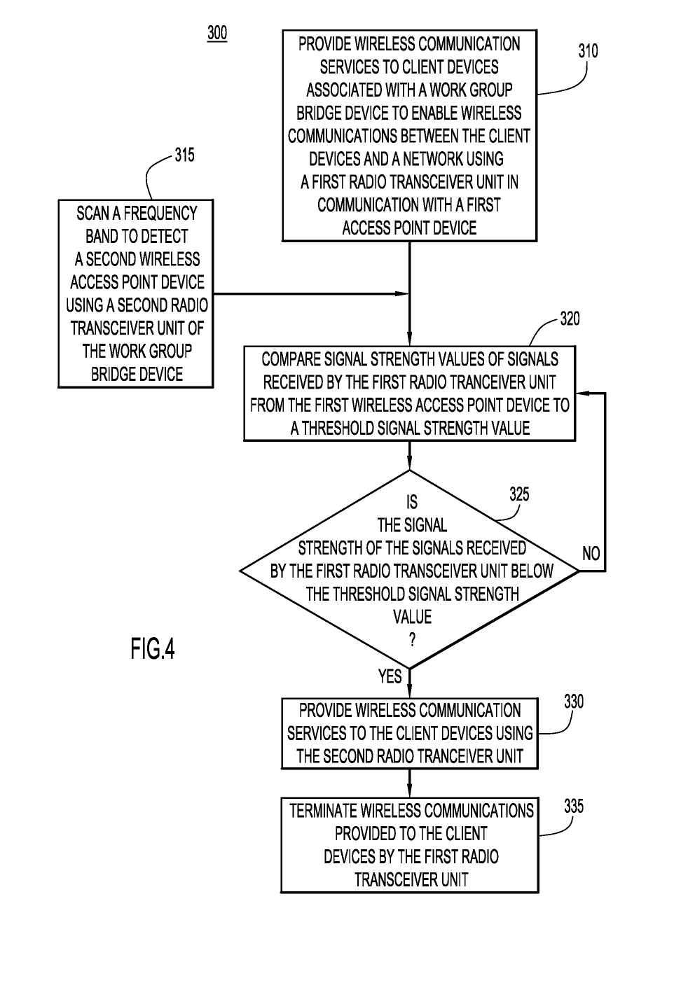

Reference is now made to FIG. 4, which shows an example flow chart depicting operations of the root access point detection and client service communication process logic 300 executed in the workgroup bridge device 110. At operation 310, the workgroup bridge device 110 provides wireless communication services to the client devices 130 associated with the workgroup bridge device 110. The wireless communication services enable wireless communications between one or more of the client devices 130 and a network (e.g., the network distribution layer 140). At the direction of the processor 230 of the workgroup bridge device 110, these services are provided by a first radio transceiver unit (e.g., the serving radio transceiver unit 205), which is in communication with a first wireless access point device (e.g., a first one of the root access points 120(a)-120(n)). At operation 315, the processor 230 instructs a second radio transceiver unit of the workgroup bridge device (e.g., the scanning radio transceiver unit 215) to scan a frequency band in order to detect a second wireless access point device (e.g., a second one of the root access points 120(a)-120(n)). Signal strength values of signals received by the first radio transceiver unit from the first wireless access point device are compared, at 320, to a threshold signal strength value.

A determination is made, at 325, as to whether the signal strength of the signals received by the first radio transceiver unit is below the threshold signal strength value. If the signal strength of the received signals is less than the threshold signal strength value (i.e., if the answer to decision 325 is “Yes”), the workgroup bridge device 110, at 330, provides wireless communication services to the client devices 130 using the second radio transceiver unit and, at 335, terminates wireless communications provided to the client devices 130 by the first radio transceiver unit. If the strength of the received signals is greater than the threshold signal strength value (i.e., if the answer to decision 325 is “No”), then the workgroup bridge device 110 reverts to operation 320 to perform the comparison again, possibly after some wait interval.

It should be appreciated that there may be multiple ways to determine whether the signal strength is below the threshold signal strength value. For example, there may be multiple factors that may be measured to determine the signal strength, such as packet retries, beacon loss, reception rates, etc.

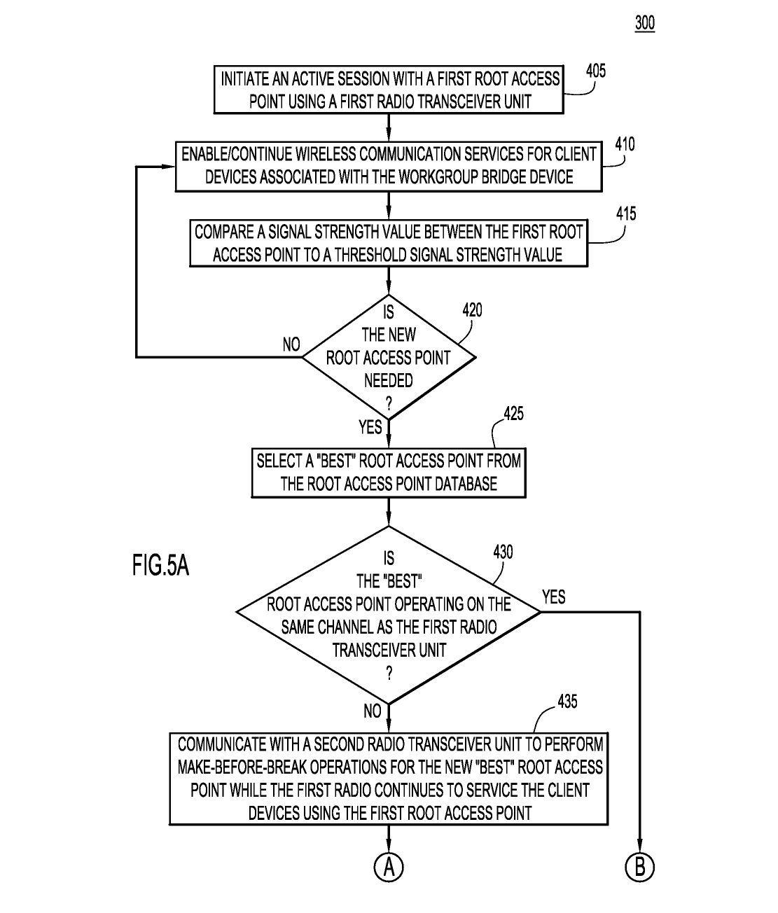

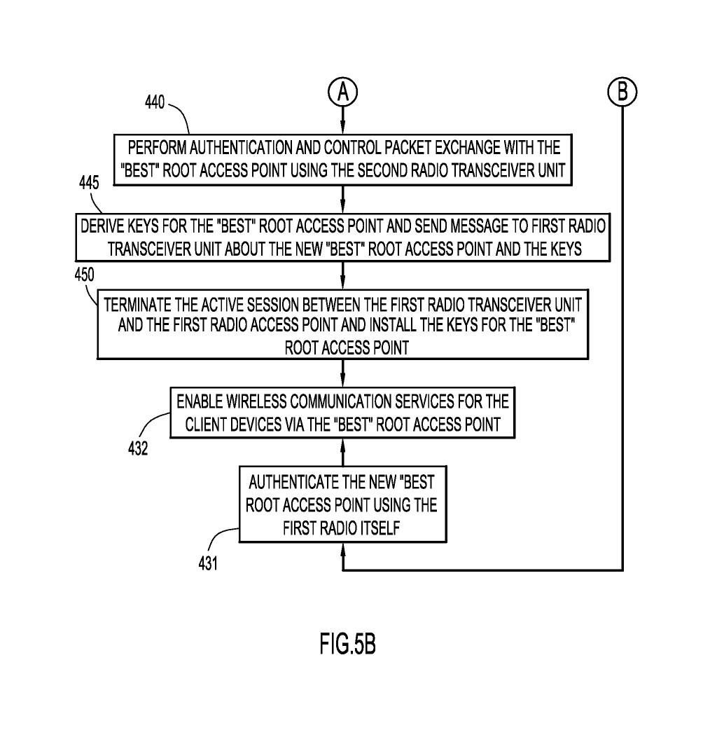

Reference is now made to FIGS. 5A and 5B. FIGS. 5A and 5B show a flow charts depicting operations of the root access point detection and client service communication process logic 300 for transitioning wireless communication services from the serving radio transceiver unit 205 to the scanning radio transceiver unit 215 of the workgroup bridge device 110. In FIG. 5A, at operation 405, the workgroup bridge device 110, at the direction of the processor 230, initiates an active session with a first root access point (e.g., root access point 120(a) in FIG. 1) using a first radio transceiver unit (e.g., serving radio transceiver unit 205). After initiating the session, the workgroup bridge device 110, at 410, enables wireless communication services for the client devices 130 associated with the workgroup bridge device 410. As described above, these wireless communication services enable the client devices 130 to transmit and receive frames and packets with the network distribution layer 140 via the workgroup bridge device 110 and the first root access point.

At 415, the processor 230 of the workgroup bridge device 110 compares a signal strength value between the first root access point to a threshold signal strength value (as described above in FIG. 4). Based on this comparison, a determination is made, at 420, as to whether a new root access point is needed. If a new root access point is not needed, the process reverts to operation 410 to continue wireless communication services. If a new root access point is needed, e.g., if as stated above, the signal strength value is below the threshold signal strength value, then the processor 230 of the workgroup bridge device 110, at 425, will select a second (“best”) root access point (e.g., a second root access point root access point 120(b) in FIG. 1) from the root access point database 245. For example, the processor 230 of the workgroup bridge device 110 will evaluate the relative priority information stored in the root access point database 245 for each detected root access point and will select the “best” root access point based on the relative priority information.

After selecting the “best” root access point, the processor 230 of the workgroup bridge device 110, at 430, will determine whether the “best” root access point is operating on the same channel (e.g., frequency channel) as the first radio transceiver unit. The workgroup bridge device 110 may determine whether the “best” root access point is in the same channel by evaluating channel characteristics associated with signals received from the “best” root access point. If the “best” root access point is operating on the same channel as the first radio transceiver unit, the processor 230 of the work group bridge device 110 will, at operation 431 in FIG. 5B, authenticate the new best root access point using the first radio transceiver unit itself and at 432 will cause the first radio transceiver unit to switch to the “best” root access point in order to enable wireless communications for the client devices via the “best” root access point.

If the “best” root access point is not operating on the same channel as the first radio transceiver unit, the processor 230 of the workgroup bridge device 110 will still cause the first radio transceiver unit to switch to the “best” root access point and, at 435, will cause the first radio transceiver unit to communicate with a second radio transceiver unit (e.g., scanning radio transceiver unit 215) to perform make-before-break operations before switching root access points. The make-before-break operations are relay or switch operations performed by the processor 230 of the workgroup bridge device 110 that allow for the first radio transceiver unit to transfer all wireless communication services with the client devices 130 to the second radio transceiver unit before disconnecting or terminating the active session with the first root access point. In other words, the first radio transceiver unit “makes” or transfers wireless communication services to the second radio transceiver unit before it “breaks” the active session between the workgroup bridge device 110 and the first root access point.

After performing the make-before-break operations in operation 435, the processor 230 of the workgroup bridge device 110, at 440 in FIG. 5B, performs an authentication and control packet exchange with the “best” root access point using the second radio transceiver unit. At 445, keys are then derived for the “best” root access point, and a message containing the keys is sent to the first radio transceiver unit about the new “best” root access point. At 450, the processor 230 of the workgroup bridge device 110 terminates the active session between the first radio transceiver unit and the first radio access point and installs the keys for the “best” root access point. After the active session between the first radio transceiver unit and the first radio access point is terminated, the processor 230 of the workgroup bridge device 110 enables wireless communication services for one or more client devices via the “best” root access point, as shown in reference numeral 432.

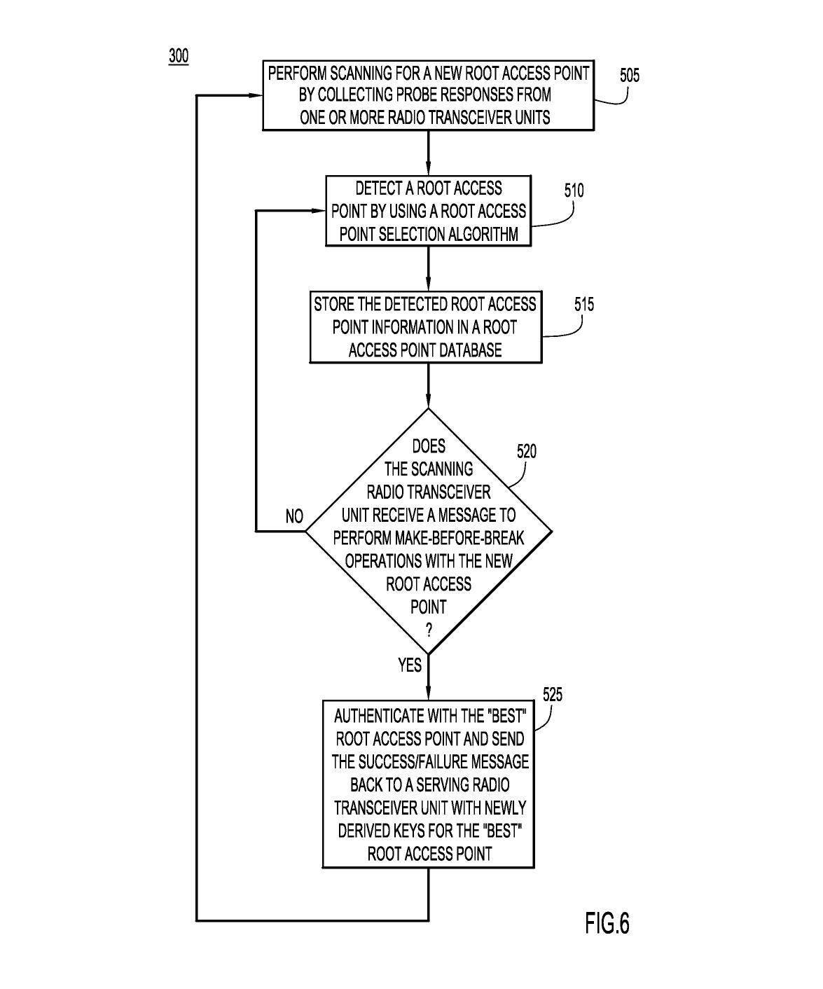

Reference is now made to FIG. 6. FIG. 6 shows an example flow chart depicting operations of the root access point detection and client service communication process logic 300 for operating scanning radio transceiver unit 215. At 505, the processor 230 of the workgroup bridge device 110 causes the scanning radio transceiver unit 215 to perform scanning for a new root access point by collecting probe responses from one or more radio transceiver units. At 510, the processor 230 detects a root access point (e.g., root access point 120(a)-120(n)) within a frequency band by using a root access point selection algorithm. For example, the scanning radio transceiver unit 215 may scan a frequency band in the network topology 100 to determine root access points within the frequency band. At 515, the root access point information for the detected root access point is stored in the root access point database 245. At 520, the processor 230 of the workgroup bridge device 110 determines whether the scanning radio transceiver unit 215 receives a message to perform a make-before-break switch operation with the new root access point. If is determined that the scanning radio transceiver unit 205 is to perform the make-before-break switch operation, at 525, the processor 230 authenticates the new (e.g., “best”) root access point and sends the success/failure message back to a serving radio transceiver unit with newly derived keys for the “best” root access point. The process then reverts to operation 505. If it is determined that the scanning radio transceiver unit 205 is not to perform the make-before-break switch operation, the process reverts to operation 510.

In sum, a method is provided comprising: at a workgroup bridge device, providing wireless communication services to client devices associated with the workgroup bridge device to enable wireless communications between the client devices and a network using a first radio transceiver unit of the workgroup bridge device in communication with a first wireless root access point device that is configured to provide connectivity to the network; controlling a second radio transceiver unit of the workgroup bridge device to scan a frequency band to detect a second wireless root access point device; comparing signal strength values of signals received by the first radio transceiver unit from the first wireless root access point device to a threshold signal strength value; providing the wireless communication services to the client devices associated with the workgroup bridge device using the second radio transceiver unit of the workgroup bridge device in communication with the second wireless root access point device when the signal strength of the signals received by the first radio transceiver unit from the first wireless root access point is below the threshold signal strength value; and terminating wireless communication services provided to the client devices by the first radio in communication with the first wireless root access point device.

In addition, an apparatus is provided comprising: a first radio transceiver unit configured to transmit and receive signals in a wireless network; a second radio transceiver unit configured to transmit and receive signals in the wireless network; and a processor coupled to the first radio transceiver unit, the second radio transceiver unit and the memory and configured to: provide wireless communication services to client devices to enable wireless communications between the client devices and a network using the first radio transceiver unit in communication with a first wireless root access point device that is configured to provide connectivity to the network; control the second radio transceiver unit to scan a frequency band to detect a second wireless root access point device; compare signal strength values of signals received by the first radio transceiver unit from the first wireless root access point device to a threshold signal strength value; provide the wireless communication services to the client devices using the second radio transceiver unit of the workgroup bridge device in communication with the second wireless root access point device when the signal strength of the signals received by the first radio transceiver unit from the wireless root access point is below the threshold signal strength value; and terminate wireless communication services provided to the client devices using the first radio transceiver unit in communication with the first wireless root access point device.

Furthermore, one or more computer readable storage media encoded with software comprising computer executable instructions and when the software is executed operable to: provide wireless communication services to client devices to enable wireless communications between the client devices and a network using a first radio transceiver unit in communication with a first wireless root access point device that is configured to provide connectivity to the network; control a second radio transceiver unit to scan a frequency band to detect a second wireless root access point device; compare signal strength values of signals received by the first radio transceiver unit from the first wireless root access point device to a threshold signal strength value; provide the wireless communication services to the client devices using the second radio transceiver unit of the workgroup bridge device in communication with the second wireless root access point device when the signal strength of the signals received by the first radio transceiver unit from the first wireless root access point is below the threshold signal strength value; and terminate wireless communication services provided to the client devices by the first radio transceiver unit in communication with the first wireless root access point device.

The above description is intended by way of example only.

What is claimed is:

1. A method comprising:
at a workgroup bridge device, providing wireless communication services to client devices associated with the workgroup bridge device to enable wireless communications between the client devices and a network using a first radio transceiver unit of the workgroup bridge device in communication with a first wireless root access point device that is configured to provide connectivity to the network;
controlling a second radio transceiver unit of the workgroup bridge device to scan a frequency band to detect a second wireless root access point device;
comparing signal strength values of signals received by the first radio transceiver unit from the first wireless root access point device to a threshold signal strength value;
providing the wireless communication services to the client devices associated with the workgroup bridge device using the second radio transceiver unit of the workgroup bridge device in communication with the second wireless root access point device when the signal strength of the signals received by the first radio transceiver unit from the first wireless root access point is below the threshold signal strength value; and
terminating wireless communication services provided to the client devices by the first radio transceiver unit in communication with the first wireless root access point device.

2. The method of claim 1, wherein scanning comprises scanning the frequency band with the second radio transceiver unit to detect a third access point device.

3. The method of claim 1, wherein providing the wireless communication services to the client devices using the second radio transceiver unit is performed when channel characteristics associated with signals received from the second wireless root access point device indicate that the second wireless root access point device is not operating in a same frequency channel as the first radio transceiver unit.

4. The method of claim 1, wherein scanning comprises scanning the frequency band to detect multiple wireless root access point devices and storing priority status information representing relative signal strength values between each of the multiple wireless root access point devices and the second radio transceiver unit.

5. The method of claim 1, further comprising:
generating authentication keys used for authentication of communications between the workgroup bridge device and the second wireless root access point device; and
authenticating the workgroup bridge device with the second wireless root access point device using the authentication keys to provide wireless communication services to the client devices using the second radio transceiver unit.

6. The method of claim 1, wherein providing the wireless communication services to the client devices using the second radio transceiver unit comprises performing a make-before-break switch between the first radio transceiver unit in communication with the first wireless root access point device and the second radio transceiver unit in communication with the second wireless root access point device.

7. The method of claim 6, wherein performing the make-before-break switch comprises transferring the wireless communication services from the first radio transceiver unit in communication with the first wireless root access point device to the second radio transceiver unit in communication with the second wireless root access point device.

8. The method of claim 6, wherein performing the make-before-break switch comprises performing the make-before-break switch before the terminating.

9. The method of claim 1, wherein providing comprises providing the wireless communication services to client devices associated with the workgroup bridge device, wherein the workgroup bridge device travels in a rapid movement direction relative to locations of the first wireless root access point device and the second wireless root access point device.

10. An apparatus comprising:
a first radio transceiver unit configured to transmit and receive signals in a wireless network;
a second radio transceiver unit configured to transmit and receive signals in the wireless network; and
a processor coupled to the first radio transceiver unit, the second radio transceiver unit and the memory and configured to:
provide wireless communication services to client devices to enable wireless communications between the client devices and a network using the first radio transceiver unit in communication with a first wireless root access point device that is configured to provide connectivity to the network;
control the second radio transceiver unit to scan a frequency band to detect a second wireless root access point device;
compare signal strength values of signals received by the first radio transceiver unit from the first wireless root access point device to a threshold signal strength value;
provide the wireless communication services to the client devices using the second radio transceiver unit of the workgroup bridge device in communication with the second wireless root access point device when the signal strength of the signals received by the first radio transceiver unit from the first wireless root access point is below the threshold signal strength value; and
terminate wireless communication services provided to the client devices using the first radio transceiver unit in communication with the first wireless root access point device.

11. The apparatus of claim 10, wherein the processor is further configured to control the second radio transceiver unit to scan the frequency band to detect a third access point device.

12. The apparatus of claim 10, wherein the processor is further configured to provide the wireless communication services to the client devices when channel characteristics associated with signals received from the second wireless root access point device indicate that the second wireless root access point device is not operating in a same frequency channel as the first radio transceiver unit.

13. The apparatus of claim 10, wherein the processor is further configured to control the second radio transceiver unit to scan the frequency band to detect multiple wireless root access point devices and store priority status information representing relative signal strength values between each of the multiple wireless root access point devices and the second radio transceiver unit.

14. The apparatus of claim 10, wherein the processor is further configured to:
generate authentication keys for authentication with the second wireless root access point device; and
authenticate with the second wireless root access point device using the authentication keys to provide wireless communication services to the client devices using the second radio transceiver unit.

15. The apparatus of claim 10, wherein the processor is further configured to perform a make-before-break switch between the first radio transceiver unit in communication with the first wireless root access point device and the second radio transceiver unit in communication with the second wireless root access point device.

16. The apparatus of claim 15, wherein the processor is further configured to perform the make-before-break switch by transferring the wireless communication services from the first radio transceiver unit in communication with the first wireless root access point device to the second radio transceiver unit in communication with the second wireless root access point device.

17. The apparatus of claim 15, wherein the processor is configured to perform the make-before-break switch before terminating the wireless communication services provided to the client devices by the first radio transceiver unit.

18. One or more computer readable storage media encoded with software comprising computer executable instructions and when the software is executed operable to:
provide wireless communication services to client devices to enable wireless communications between the client devices and a network using a first radio transceiver unit in communication with a first wireless root access point device that is configured to provide connectivity to a network;
control a second radio transceiver unit to scan a frequency band to detect a second wireless root access point device;
compare signal strength values of signals received by the first radio transceiver unit from the first wireless root access point device to a threshold signal strength value;
provide the wireless communication services to the client devices using the second radio transceiver unit of the workgroup bridge device in communication with the second wireless root access point device when the signal strength of the signals received by the first radio transceiver unit from the first wireless root access point is below the threshold signal strength value; and
terminate wireless communication services provided to the client devices by the first radio transceiver unit in communication with the first wireless root access point device.

19. The computer readable storage media of claim 18, further comprising instructions operable to control the second radio transceiver unit to scan the frequency band to detect a third access point device.

20. The computer readable storage media of claim 18, further comprising instructions operable to provide the wireless communication services to the client devices when channel characteristics associated with signals received from the second wireless root access point device indicate that the second wireless root access point device is not operating in a same frequency channel as the first radio transceiver unit.
